(19) United States
(12) Patent Application Publication
(10) Pub. No.: US 2008/0301561 A1
(43) Pub. Date: Dec. 4, 2008

(54) Apparatus and method for automation of multimedia-enabled correspondence management systems (MCMS)

(76) Inventor: David Bain, Arlington, VA (US)

Correspondence Address: MEREK, BLACKMON & VOORHEES, LLC, 673 S. WASHINGTON ST., ALEXANDRIA, VA, 22314, US

(21) Appl. No.: 11/512,371

(22) Filed: Aug. 30, 2006

Related U.S. Application Data
(60) Provisional application No. 60/712,091, filed on Aug. 30, 2005.

(51) Int. Cl. G06F 3/048; G06F 15/16

(52) U.S. Cl. 715/730; 709/224; 715/753

(57) ABSTRACT

A system for sending large numbers of personalized multimedia communications to other people by automating the creation and delivery of custom one-to-one and template-driven one-to-many video and/or audio (multimedia) communications. The present invention also provides an automated means for a message originator to select and direct a third party to create customized multimedia content. Using the system, a user can select among the duly registered performers in the system's database, and direct such a third party or parties such as a Hollywood celebrities to perform a holiday greeting for a colleague. The invention also allows for classifying, saving and re-using multimedia content or parts of multimedia content and for the combining or matching of multimedia content custom-tailored to specific recipients, such as recorded salutations, with additional multimedia content, such as an explanation of a politician's position on a particular issue.

This application claims priority to US. Provisional Application 60/712,091 filed Aug. 30, 2005, which is hereby incorporated by reference.

### BACKGROUND OF THE INVENTION

Executives, celebrities, government officials and others maintain extensive communication lists, mailing lists, etc. for constituents, fans, prospective buyers, or others that they must contact on an on-going or periodic basis. Because of the large sizes of these lists, it is desirable to have automated and template-driven ways to manage and track interactions with people taking into account their affiliations and previous interactions. For instance, a Member of Congress may want to send template-based, yet personalized correspondence to a list of constituents in one district or all of the teachers in a state, or a personal note of thanks to all the constituents who contributed to a campaign.

Correspondence management systems, also known as constituent management services (CMS), are relied upon by executives, celebrities, appointed and elected officials (including Members of Congress), and other VIPs as stand-alone or integrated systems to manage all the communications of an individual or organization. CMS installations facilitate interaction with constituents, allowing a small staff to manage interactions with a massive number of correspondents and track or report on those interactions. Known CMS packages allow for personalization of text-based correspondence using merge fields based on virtually any variable stored in the system database, including general data or data specific to individual correspondents, such as names and addresses. For instance, if a constituent writes to their representative in Congress about a particular issue, the Congressional staff will likely use a CMS system to generate a letter in response using a letter template about that issue. The response may give the impression of personalization by virtue of merging in of the address and salutation information that is specific to that constituent, i.e. “Dear Mr. Jones, Thank you for writing me about Social Security.”.

One drawback to this prevailing method is the fact that a growing number of people are aware that their letters are not read personally by the Member of Congress and that the responses are not really signed by the Member nor written specifically for the recipient. Another drawback is that when it comes to making a message interesting, appealing, and convincing to the target audience, any purely text-based medium has inherent limitations.

Known CMS packages do not incorporate a facility for instruction- or template-based production and delivery of video or audio content. Known CMS systems do not incorporate any means of multimedia production and delivery.

Known video and multimedia services and applications are limited to either one-to-one” communication (such as with Comcast videomail), or for a broadcast model “one-to-many” communication (such as with YouTube or Google video). Known systems do not allow for customizable, personalized yet instruction- or template-driven and automated production and delivery of multimedia content as described herein. Without the present invention, it would be cost- and time-prohibitive for CMS users to engage in custom-tailored multimedia communications with a significant number of constituents.

### SUMMARY OF THE INVENTION

The present invention makes it possible for anyone to send large numbers of personalized multimedia communications to people everywhere by automating the creation and delivery of custom “one-to-one” and template-driven “one-to-many” video and/or audio (multimedia) communications as guided by a Correspondence Management System (CMS). With the invention, members of Congress, for instance, could within 1 hour cost-effectively capture, deliver, and track very many short custom multimedia messages to the organizers of an upcoming fundraiser. Secondly, the invention provides the first automated means for an originator of a message or system user to select and direct a third party to create customized multimedia content. For instance, using the MCMS system, a user can select among the duly registered performers in the system's database, and direct such a third party or parties (such as a Hollywood celebrities) to perform a birthday or holiday greeting for a colleague; without such a system, it is entirely impractical for most people to hire the services of any celebrity, but by using the invention, ordinary people are able to contract for the time of famous people in affordable chunks of one minute or less. Thirdly, the invention allows for classifying, saving and re-using multimedia content or parts of multimedia content. Fourthly, the invention allows for the combining or matching of multimedia content that is custom-tailored to specific recipients, such as recorded salutations, with additional multimedia content, such as an explanation of a politician's position on a particular issue. In other words, the invention enables users to produce multimedia files that are automatically spliced together from multiple files. Lastly, the invention allows for the storage and mining of data relating to the viewing of content generated through the system.

As shown in FIG. 5, the invention includes computer hardware (a web and application server 1 with database 2), recording/image capture devices 4 (which may range from a mobile phone to a computer with a web camera and microphone to a high-end television studio camera with studio teleprompting system), network infrastructure 7, all of which are well-known to individuals knowledgeable in the art of computer videography, and software that may reside on local or network-based computers. The core elements of the invention include the following:
1. Multimedia capture software (running on a capture device such as computer with video camera or cell phone/PDA with video and audio capture capabilities) to queue and teleprompt the recording of multimedia content; and
2. Specially adapted CMS or CRM software to provide administrator and staff interfaces, store libraries of recorded multimedia messages, set up, process and track the delivery of messages.
3. Using the invention, a CMS user, such as a member of Congress, gains the ability to 1) make issue-specific multimedia material available to correspondents based on their interests, and 2) cost- and time-effectively manufacture and deliver custom multimedia material to specific correspondents, and 3) maintain a detailed searchable record of all such communications.

The invention is intended to be an apparatus and method for facilitating and automating the arranging, performing, delivering, and tracking the consumption of audio, video, or multimedia content for custom “one-to-one” and template-driven “one-to-many” communications; and, an apparatus and method of an electronic interface (web-based or otherwise) through which performers are prompted (using audio prompting, telepompters, or other available means) so that they may perform one or a queued series of custom performances in the least amount of time; and, an apparatus and method of adopting the aforementioned Invention for the arranging and real-time or live performing, and delivering of audio, video, or multimedia content; and, an apparatus and method of adopting the aforementioned Invention for use with Correspondence Management Systems (CMS) as are commonly used by elected officials to facilitate the processes of interaction between officials and constituents such that CMS users may efficiently correspond with others in audio, video, or multimedia format; and, an apparatus and method of incorporating into the aforementioned Invention Teleprompter-enabled, order queue-enabled, semi-automated system for system users to capture multimedia content; and, an apparatus and method of incorporating into the aforementioned Invention the means to select among multiple performers, and, an apparatus and method for those multiple performers to be duly registered in the system; and, an apparatus and method of incorporating into the aforementioned Invention the means of reporting on and compensating performers for completed performances.

### BRIEF DESCRIPTION OF THE FIGURES

FIG. 1 is an example of a main screen for an MCMS system that is adapted for use with elected officials.

FIG. 2 is an example of an interface within the MCMS system for setting up or viewing the details of an outgoing message.

FIG. 3 is an example an interface used to design templates employed by the MCMS system.

FIG. 4 is an example of a multimedia capture interface, through which a performers create and upload multimedia content to a database.

FIG. 5 is an example diagram of an MCMS architecture.

### DETAILED DESCRIPTION OF THE PREFERRED EMBODIMENTS

In its ideal embodiment, the MCMS allows a user to prepare outgoing messages, either individually or en masse, select recipients, and select correspondence templates for merging recipient-specific or other information into outgoing messages, as with prior CMS systems. However, in addition to these previously available options, MCMS users are able to tag outgoing messages for the inclusion of video/multimedia content or URLs where such content may be accessed. In case the content is password-protected, such login information may be inserted into the outgoing text communication via a merge field.

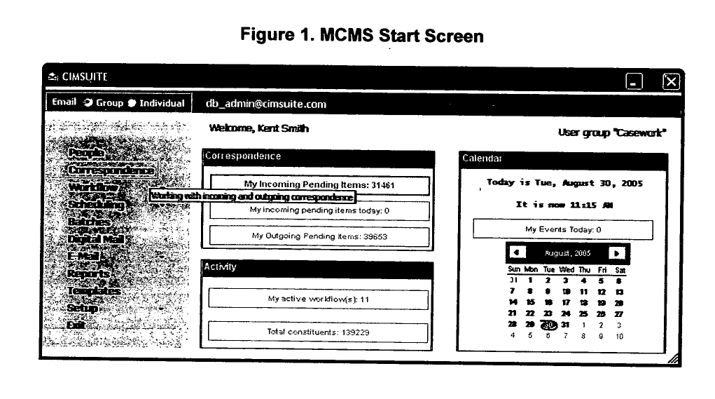

To use the MCMS, the user or originator of the message may begin by navigating to the main screen of an MCMS, represented by FIG. 1. The main screen depicted in FIG. 1 is adapted for the complex needs of the correspondence staff of elected officials, so further implementations of such interfaces may be significantly simplified. The software application generating such an interface may run locally on the computing device used to access the system or as a browser- or service-based application accessing an application server and database via a data network, such as the Internet. From the main screen, the user should click the appropriate buttons to open screens allowing for the creation of a new outgoing message. From the screen in FIG. 1, the user can achieve this by clicking on the People button, searching in the resulting standard dialogue box for a person or list of people in the database to whom the message will be sent and then selecting to create a new outgoing message to the found set of people.

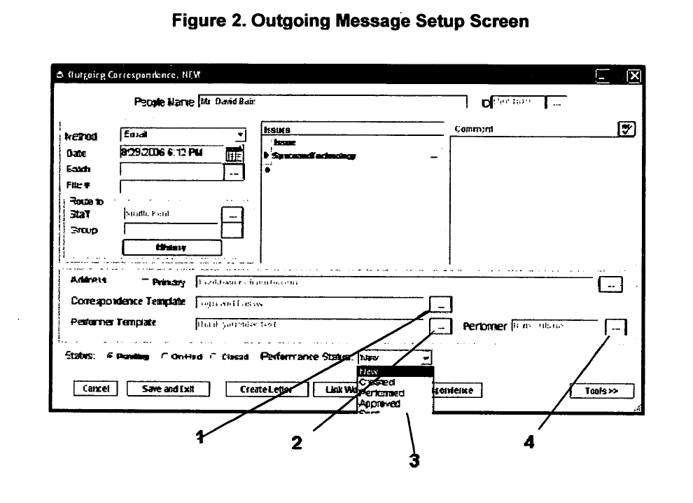

The resulting outgoing message setup screen, shown in FIG. 2, allows a user to further set up the message that will be sent to the recipient or batch of recipients. The user may then adjust the method of delivery, such a postal mail or email, and specify the relevant address information as is standard in CMS system use. Next, as shown on FIG. 2, the user may select a correspondence template by clicking on the Correspondence Template selection button 1. A library of letter templates that will comprise the text sent to the recipient(s) appears in a standard dialogue box so that the user may select among them. These letter templates contain merge fields so that when the letter files are later generated by the system, the fields are populated with dynamically-inserted information, such as the name or information specific to each respective recipient. The letter templates may also contain merge fields that populate with information directing the recipient to a URL or other location where they may access multimedia content that will be dynamically produced for them.

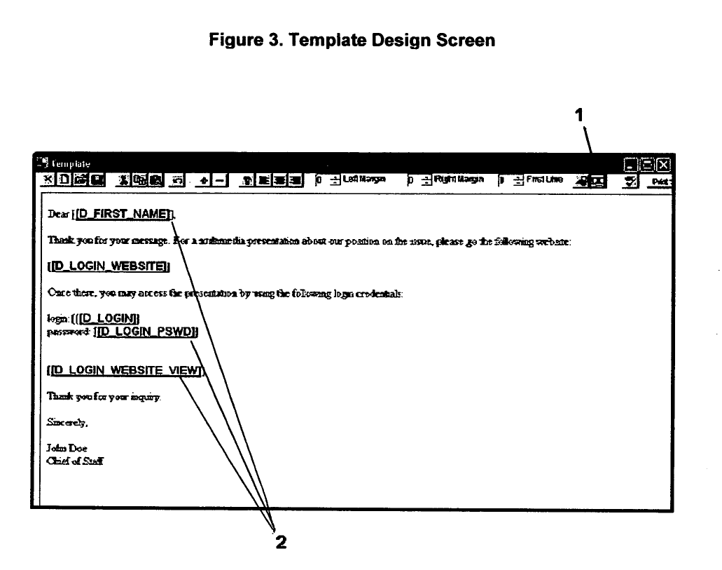

In FIG. 2, the Performance Template selection button 2 allows the user to select from a library of templates to be used by the performer of the multimedia content whose location is referenced in the letter template. This template may also contain merge fields and may consist of text which the performer is intended to read and/or instructions the performer is intended to follow, such as “sing the song ‘Happy Birthday’”. FIG. 3 depicts a template design interface used to layout the text and merge fields 2 in a letter or performance template. Merge fields 2 that relate to any value stored in the database or accessible to the system may be inserted by clicking on the merge field insertion icon 1.

The user may then click on the Performer selection button 4 to search and select from a standard menu of performers who are registered in the system and available to perform the content. In the instance of a MCMS system implemented for a political office, the available performers might, for instance, include politicians, members of their staffs, and their well-known or well-spoken endorsers. In the instance of a MCMS implementation for a greeting card or marketing company, the available performers may include celebrities and various and diverse spokespersons. In the instance that many performers are registered in the system, potential performers may be searched for using widely accepted search methods and prioritized according to price per minute, popularity, customer feedback ratings, age, sex, or other searchable criteria. It should be evident to those skilled in the art of internet commerce that this sort of implementation could be extended to include all permutations of known pricing models including auctions, reverse auctions, bulk purchase, and secondary markets. It is further conceivable that the asking price of performers could be variable according to whether advertisements are embedded in or otherwise accompany the content, i.e. a performer may charge a user only $5 per minute if he or she is getting another $20 per minute from a featured soft drink manufacturer. Furthermore, price may be variable according to other factors including, but not limited to content size and quality (in terms of, for instance, screen size and resolution, or sampling rate), and rights for the further use and ownership of the content. For instance, a minute of a performance intended to be viewed once may cost much less than content that conveys ownership rights with the right to redistribute the content of make derivative works on its basis.

Upon clicking to create the letter, both the text-based letter to be sent to the recipient and the performance template are generated dynamically and saved in the database with any merge fields in the templates being populated based on values in the database. Since the multimedia performance has not yet been rendered, the Performance Status indicator 3 displays “New”. The performer is notified electronically, such as through a pager, email, or text message, of the need to perform a message and the message is added to the queue of the performer.

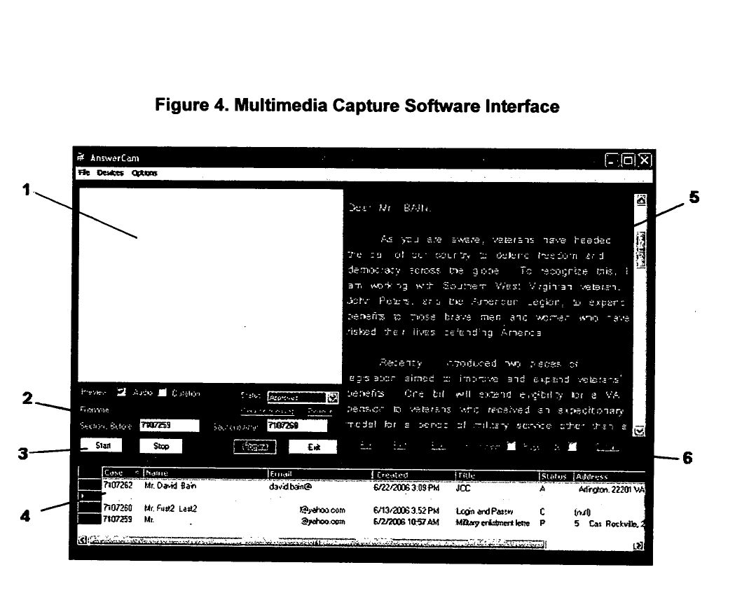

When the performer opens the multimedia capture software, shown in FIG. 4, the messages needing to be performed are in a list 4. Clicking on a message makes the now merged text from the performance template appear in the on-screen teleprompter 5 so that the performer may click the start button 3 to begin recording the message while reading the teleprompter or following directions in the teleprompt area, such as “sing ‘Happy Birthday’ to Rob.” The teleprompting mode and options, such as speed, font size, and other scrolling mode settings are accessed through the options hyperlink 6. The preview pane 1 allows performers to see themselves so they may ensure that they are properly in frame. If satisfied with the performance, the performer clicks to ‘Commit’ or upload the performance causing the multimedia capture software to upload the multimedia file to the database or database-referenced storage location. In the event that the content should be preceded or followed by other content, the adjoining media segments select box 2 may contain the file names of content that is to be spliced together with the presently performed content. Performers with large lists of requested performances may search and prioritize performance requests according to criteria including but not limited to time received, payment amount, or expiration of invitation to perform times.

After the production and uploading of the content, the FIG. 2. Performance Status indicator 3 changes to “Created”, and the original text message to the recipient, which references the location where the multimedia content may be accessed along with any login and password information, is dispatched either automatically or after the intervening step of the original sender or system user first verifying the integrity or quality the performance.

The recipient receives the message, in its most likely embodiment via e-mail, containing the Internet or other network-based link to the multimedia performance. The browser screen containing the recorded performance may provide access to additional information or navigation options.

When an outgoing communication is tagged for the inclusion of video/multimedia content, options are available, based on available methods of delivery such as postal mail, fax, SMS, MMS, voicemail, instant messaging network, email and others.

The preferred embodiment is to send the recipient an email containing a URL where the recipient may view the multimedia message, since this allows the outgoing message size to be small, allows additional options for tracking viewer statistics, allows greater options for content rights management, password protection, removing or updating multimedia content, and allows for the redirecting of the recipient to other web content following or along with the message.

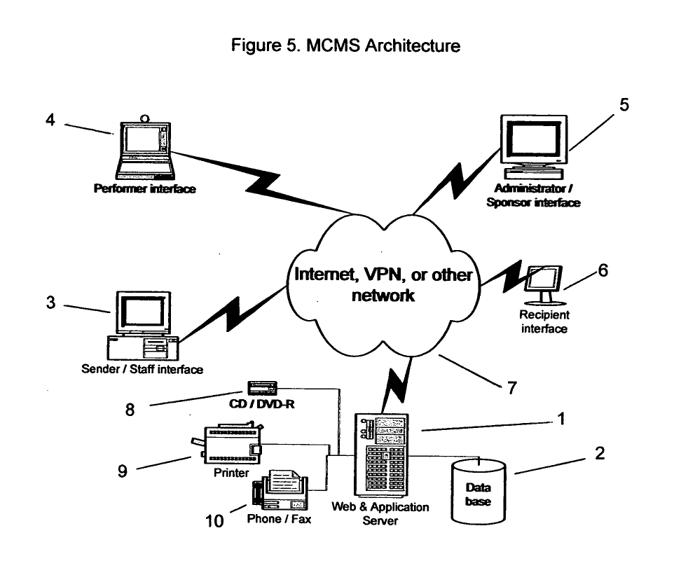

Depicted in FIG. 5, the recipient interface 6 may also collect information or feedback from the recipient.

The outgoing multimedia content may consist of one of the following:
a pre-recorded “canned” message, as may relate to a particular issue; or
a message that is complete custom, such as a personal greeting; or
a message that that is a combination of multiple parts, which may include both custom and pre-recorded elements, such as a message relating to a particular policy issue that begins with a personalized salutation. The CMS owner may also record a personalized salutation, such as “Greetings Mr. Davis, I thank you for your letter from Little Rock the following clip discusses my position on the issue you contacted me about . . . ”, to be followed by stock footage relating to a specific issue.

In this way, the captured content may comprise the entire outgoing message, or the content may be integrated with text or other content.

When an outgoing message is tagged to include multimedia content, the MCMS system links that content to the outgoing record if the content already exists (such as in the case of pre-recorded content). If the content or some part of the content still needs to be performed and captured, the outgoing record is given a status label designating this, so that it may be queued for performers with other such messages.

The MCMS allows such records to be searched and arranged in order according to all available criteria. Outgoing messages to be performed may be sorted according to subject area, or other criteria to facilitate recording. For instance, a CMS owner Member of Congress may choose to perform 25 personalized outgoing messages to VIPs in his district on his position with respect to environmental causes, each with a duration of 25 seconds. The recording of the content is achieved using standard computer multimedia capture techniques combined with an on-screen teleprompter which displays the information the performer is intended to convey. The recordings for the outgoing messages may be performed in succession such that the user manually selects individual outgoing records and selects to start recording outgoing messages. The user may also select for the MCMS to rapidly feed a queue of outgoing records, with a high degree of automation surrounding the initiating the teleprompting and capture of content so that, for instance, 58 or 59 1-minute spots may be captured in about one hour.

Neither staff members preparing outgoing records nor performers providing the content need be local to the MCMS or with one another in the event that they are able to access their respective features remotely via the web or other computer networks. Remote access may be achieved via a browser or client-server linkage over a Virtual Private Network. The owner will login to the CMS system via their video/audio enabled device (computer, PDA, cell phone, etc) and select options to begin performing one or more outgoing messages. After the performance of an individual message, performers select to submit or commit the performance at which time it may be either directly sent to the recipient or first reviewed by the CMS user before actual delivery is made.

As each order is recorded and submitted it is transmitted to a standard server where it is queued for fulfillment according to its requested method and time of delivery. Orders may also be checked for quality control purposes. Following delivery, recipients have the opportunity to offer their feedback. Delivery may be made by any number of possibilities, though the presently most feasible method is the delivery of a hyperlink by which a recipient may at their discretion choose to view or receive the multimedia message. Other variants include the delivery of the actual content via electronic mail or recording to media such as DVDs for postal or express delivery.

Especially in the event that a hyperlink for the multimedia content is sent, the multimedia message may include additional options such as a set period of expiration of the message, a limitation on the number of times the content may be viewed, passwords or other security measures to insure the sanctity of “eyes only” communications.

The system may be logically extended to accommodate real-time or nearly real time performances.

The abovementioned invention may also be applied to audio only messages, which would be equally novel for CMS packages. The audio only mode would be useful for CMS operator/owners who feel they make a better impression without their video image or in instances where the larger mount of bandwidth required for sending video is an issue.

Audio only mode also offers the advantage of making the segues between personalized content (ie, the personal salutation) and non-personalized content (i.e., a statement of position on a particular issue) less detectable.

The invention may be extended to accommodate charging for viewing or sponsors/underwriters may incorporate their advertising or other messages with the content.

It is assumed that the incorporation of 3-D or holographic technologies to enhance the visual impact of the invention would be an expected extension of the invention.

It is also assumed that those skilled in the arts of animation, voice fonts and voice synthesis could make a computer-generated personas be among the choices of performers on the system.

It is further assumed that those knowledgeable in the art of interactive voice response could extend this system to make one or more of the system interfaces to be navigable in a voice-driven mode.

It is further assumed that those skilled in the arts of casting for video and film could utilize the system to meet the needs of casting directors, and those skilled in directing and editing could utilize the system to film interviews, documentary or other content for film, television, radio, web and other media.

I claim:

1) Apparatus and method for facilitating the arranging, performing, delivering, and tracking consumption of audio, video, or multimedia content for custom “one-to-one” and template-driven “one-to-many” communications.

2) The apparatus and method of an electronic interface (web-based or otherwise) through which performers are prompted (using audio prompting, teleprompters, or other available means) so that they may perform one or a queued series of custom performances in the least amount of time.

3) The apparatus and method of adopting the aforementioned Invention for the arranging and real-time or live performing, and delivering of audio, video, or multimedia content.

4) The apparatus and method of adopting the aforementioned Invention for use with Correspondence Management Systems (CMS) as are commonly used by elected officials to facilitate the processes of interaction between officials and constituents such that CMS users may efficiently correspond with others in audio, video, or multimedia format.
